(19) United States
(12) Patent Application Publication
(10) Pub. No.: US 2009/0225929 A1
(43) Pub. Date: Sep. 10, 2009

(54) PETROCHEMICAL COMPLEX

(75) Inventors: Minoru Genta, Hyogo (JP); Kinya Fujita, Hyogo (JP); Ryosuke Uehara, Hyogo (JP); Masayuki Takeishi, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/096,946

(22) PCT Filed: Feb. 20, 2007
(86) PCT No.: PCT/JP2007/053007

§ 371 Date: Mar. 20, 2009

(30) Foreign Application Priority Data
Feb. 21, 2006 (JP) 2006-043249

(51) Int. Cl. G21G 1/02; G21D 9/00

(52) U.S. Cl. 376/325

(57) ABSTRACT

Provided is a petrochemical complex 100 that produces a fuel and a petrochemical, by applying heat generated in heating means to crude oil by use of a heating medium. In the petrochemical complex 100, the heating means is a light-water reactor 110.

### TECHNICAL FIELD

The present invention relates to a petrochemical complex that produces a fuel and a petrochemical by applying heat to crude oil.

### BACKGROUND ART

FIG. 4 shows a schematic configuration of an example of a conventional petrochemical complex that produces a fuel and a petrochemical by applying heat to crude oil.

As shown in FIG. 4, the conventional petrochemical complex is configured as follows. Firstly, water is heated by combusting a petroleum fuel 10 in a boiler 11, so that steam 1a (of approximately 300° C.) is generated. Then, the pressure of the steam 1a thus generated in the boiler 11 is adjusted by a first pressure reducing device 12, so that the steam 1a has a temperature in a medium temperature range (approximately from 200° C. to 300° C.). In addition, the pressure of part of the steam 1a whose pressure has been adjusted by the first pressure reducing device 12 is further adjusted by a second pressure reducing device 13, so that the part of the steam 1a has a temperature in a low temperature range (approximately from 100° C. to 200° C.). The part of the steam 1a in the low temperature range is fed to a low-temperature-range plant 15 that utilizes heat in the low temperature range. The rest of the steam 1a in the medium temperature range is fed to a medium-temperature-range plant 16 that utilizes heat in the medium temperature range. On the other hand, flame 10a in a high temperature range (approximately from 300° C. to 1200° C.) is generated by combusting the petroleum fuel 10 in a combustion furnace 14. By use of the radiant heat of the flame 10a, heat is provided to a high-temperature-range plant 17 that utilizes heat in the high temperature range. Note that, in FIG. 4, reference numeral 1b denotes a condensate that is returned to the boiler 11 after being used in the plants 15 and 16, while reference numeral lob denotes an exhaust gas from the combustion of the petroleum fuel 10.

In addition, there is another example of the conventional petrochemical complex. In this example, a liquid, such as an oil, that can be heated to a high temperature, is used as the heating medium for the medium-temperature-range plant 16, instead of the steam 1a. The liquid is heated to a temperature in the medium temperature range by use of combustion heat of the petroleum fuel 10 combusted in the boiler 11 so as to be used as the heating medium for the medium-temperature-range plant 16. Note that, in this case, the temperature of the steam 1a generated in the boiler 11 is set in the low temperature range (approximately from 100° C. to 200° C.).

### Patent Document 1: JP-A 11-019504

### Patent Document 2: JP-A 2000-002790

### DISCLOSURE OF THE INVENTION

### Problems to be Solved by the Invention

In the conventional petrochemical complex as described above, when a fuel and a petrochemical are produced from crude oil, the fuel thus produced is used as well. In other words, crude oil is used as both of a material and a heat source. Accordingly, in addition to the amount of crude oil to be used as a material necessary for producing a product to be sold as a commercial product, required is another amount of crude oil to be used as a fuel. As a result, a significant amount of crude oil is consumed, as compared with the production of a product to be sold as a commercial product. For this reason, in the conventional petrochemical complex, there is a demand for reducing the amount of consumption of crude oil as much as possible. Concurrently, there also is a strong demand for reducing the amount of a petroleum fuel to be used so that the generation of carbon dioxide can be reduced as much as possible.

In view of the above-described circumstances, an object of the present invention is to provide a petrochemical complex with which the amount of a petroleum fuel to be used can be reduced.

### Means for Solving the Problems

A first invention for solving the above-described problems provides a petrochemical complex that produces a fuel and a petrochemical, by applying heat generated in heating means to crude oil by use of a heating medium. The petrochemical complex is characterized in that the heating medium is a nuclear reactor.

The petrochemical complex according to a second invention provides the following characteristics in addition to the first invention. The nuclear reactor is a light-weight reactor, and the heating medium is steam generated through heat exchange with a light water that is a coolant of the light-weight reactor.

The petrochemical complex according to a third invention provides the following characteristics in addition to the first invention. The nuclear reactor is a fast-breeder reactor, and the heating medium is steam generated through heat exchange with liquid sodium that is a coolant of the fast-breeder reactor.

The petrochemical complex according to a fourth invention provides the following characteristics in addition to the first invention. The nuclear reactor is a high-temperature gas-cooled reactor, and the heating medium is steam generated through heat exchange with helium gas that is a coolant of the high-temperature gas-cooled reactor.

The petrochemical complex according to a fifth invention provides the following characteristics in addition to the first invention. The petrochemical complex includes a light-water reactor serving as the nuclear reactor; a steam turbine rotationally driven by use of steam generated through heat exchange with a light water that is a coolant of the light-water reactor; and a compressor connected to the steam turbine, and compressing and feeding a heat transfer gas. The petrochemical complex is also characterized in that the heating medium is the heat transfer gas compressed by, and fed from, the compressor.

The petrochemical complex according to a sixth invention provides the following characteristics in addition to the first invention. The petrochemical complex includes a fast-breeder reactor serving as the nuclear reactor; a steam turbine rotationally driven by use of steam generated through heat exchange with liquid sodium that is a coolant of the fast-breeder reactor; and a compressor connected to the steam turbine, and compressing and feeding a heat transfer gas. The petrochemical complex is also characterized in that the heating medium is the heat transfer gas compressed by, and fed from, the compressor.

The petrochemical complex according to a seventh invention provides the following characteristics in addition to the first invention. The petrochemical complex includes a high-temperature gas-cooled reactor serving as the nuclear reactor. The petrochemical complex is also characterized in that the heating medium is a heat transfer gas having exchanged heat with helium gas that is a coolant of the high-temperature gas-cooled reactor.

### EFFECT OF THE INVENTION

In the petrochemical complex according to the present invention, the heating means is the reactor. For this reason, it is possible to significantly reduce the amount of a petroleum fuel to be used, in turn reducing the amount of consumption of crude oil, and concurrently to reduce the generation of carbon dioxide.

### BRIEF DESCRIPTION OF THE DRAWINGS

FIG. 1 shows a schematic configuration of a first embodiment of a petrochemical complex according to the present invention.

FIG. 2 shows a schematic configuration of a second embodiment of the petrochemical complex according to the present invention.

FIG. 3 shows a schematic configuration of a third embodiment of the present invention.

FIG. 4 shows a schematic configuration of an example of a conventional petrochemical complex.

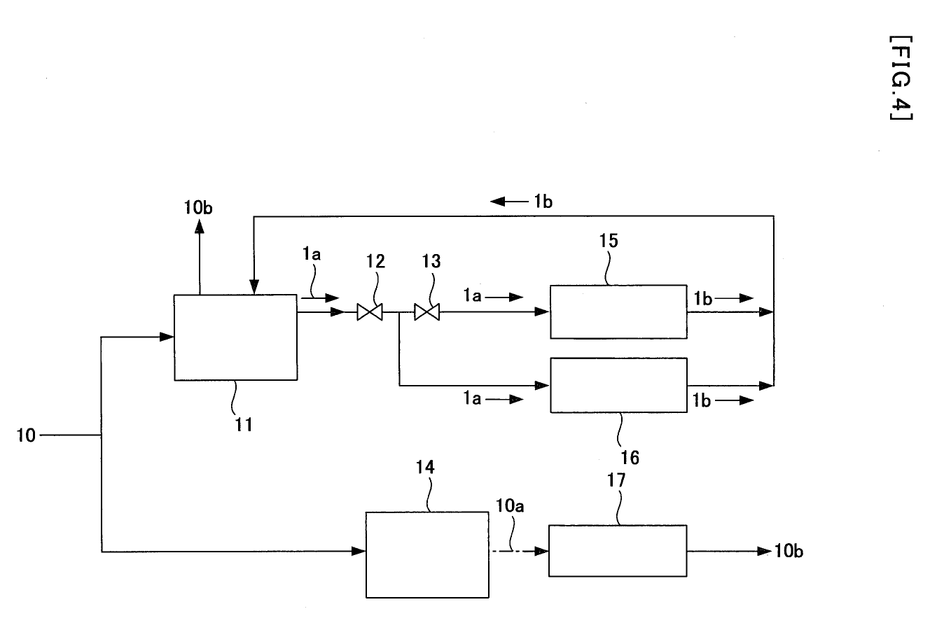

### BEST MODES FOR CARRYING OUT THE INVENTION

Hereinafter, descriptions will be given of a petrochemical complex according to the present invention with reference to the drawings. However, the petrochemical complex according to the present invention is not limited to embodiments to be described below.

### First Embodiment

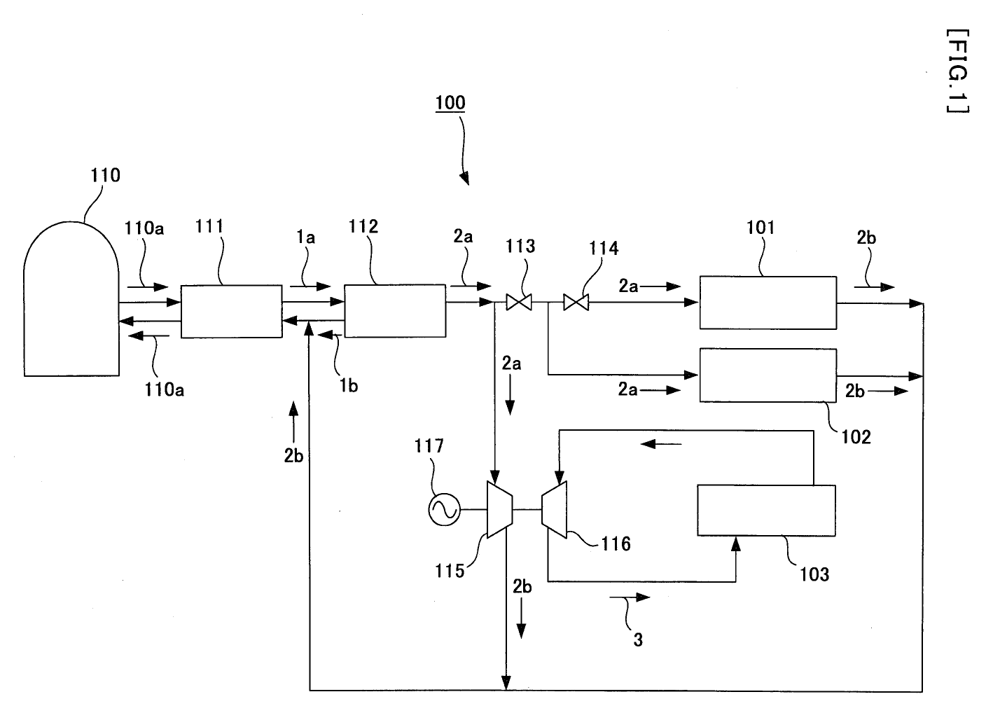

Descriptions will be given of a first embodiment of the petrochemical complex according to the present invention with reference to FIG. 1. FIG. 1 shows a schematic configuration of the petrochemical complex.

In FIG. 1, reference numeral 101 denotes a low-temperature-range plant using heat in a low temperature range (approximately from 100° C. to 200° C.), reference numeral 102 denotes a medium-temperature-range plant using heat in a medium temperature range (approximately from 200° C. to 300° C.), and reference numeral 103 denotes a high-temperature-range plant using heat in a high temperature range (approximately from 300° C. to 1200° C.). These plants 101 to 103 are capable of producing a fuel and a petrochemical by applying heat to crude oil.

In addition, reference numeral 110 denotes a light-water reactor of a boiling water type or a pressurized water type. Reference numeral 111 denotes a first steam generator. The first steam generator 111 exchanges heat with light water 110a that is a coolant of the light-water reactor 110, thus generating steam 1a serving as a heating medium. Reference numeral 112 denotes a second steam generator. The second steam generator 112 exchanges heat with the steam 1a generated in the first steam generator 111, thus generating steam 2a serving as a heating medium. It should be noted that the first and second steam generators 111 and 112 constitute steam generating means in this embodiment.

The second steam generator 112 feeds the steam 2a to the medium-temperature-range plant 102 via a first pressure reducing device 113, and concurrently to the low-temperature-range plant 101 via the first pressure reducing device 113 and a second pressure reducing device 114. Moreover, the second steam generator 112 is capable of feeding the steam 2a also to a steam turbine 115.

A compressor 116 and a power generator 117 are connected to the steam turbine 115. The compressor 116 compresses a heat transfer gas 3 serving as a heating medium, and then feeds the compressed heat transfer gas 3 to the high-temperature-range plant 103. Note that, in FIG. 1, each of reference numerals 1b and 2b denotes a condensate.

In such a petrochemical complex 100 according to this embodiment, when the light-water reactor 110 is activated, the light water 110a (of approximately 300° C.) serving as the coolant flows into the first steam generator 111, so that the steam 1a (of approximately 300° C.) is generated. Subsequently, the steam 1a thus generated flows into the second steam generator 112, so that the steam 2a (of approximately 300° C.) is generated.

The pressure of part of the steam 2a is adjusted by the first pressure reducing device 113, so that the temperature of the part falls in a medium temperature range (approximately from 200° C. to 300° C.). Thereafter, the pressure of that part of the steam 2a is partially further adjusted by the second pressure reducing device 114, so that the temperature of the part falls in a low temperature range (approximately from 100° C. to 200° C.). Thereafter, the part in the low temperature range is fed to the low-temperature-range plant 101 to be used as a heat source.

In addition, the rest of the steam 2a having the adjusted temperature in a medium temperature range (approximately from 200° C. to 300° C.) is fed to the medium-temperature-range plant 102 to be used as a heat source.

On the other hand, the rest of the steam 2a that is sent out from the second steam generator 112 is fed to the steam turbine 115, thus causing the steam turbine 115 to rotate. The rotation of the steam turbine 115 drives the compressor 116, and concurrently drives the power generator 117. The heat transfer gas 3 is compressed by the driving of the compressor 116 to have a temperature in a high temperature range (approximately from 300° C. to 1200° C.). The heat transfer gas 3 is then fed to the high-temperature-range plant 103 to be used as a heat source.

Consequently, these above-described plants 101 to 103 produce a fuel and petrochemicals by applying heat to crude oil.

In short, the petrochemical complex 100 according to this embodiment is configured to produce a fuel and a petrochemical from crude oil by: firstly causing the light-weight reactor 111 of a boiling water type or a pressurized water type to generate heat; generating the steam 2a by use of the heat, and then feeding the steam 2a to the plants 101 and 102; and concurrently compressing and heating the heat transfer gas 3 by use of the steam 2a, and then feeding the heat transfer gas 3 to the plant 103.

In this way, in the petrochemical complex 100 according to this embodiment, when a fuel and a petrochemical are produced from crude oil, it is unnecessary to use the fuel thus produced. In other words, in the petrochemical complex 100, crude oil can be used only as a material but not as a heat source.

As a result, the petrochemical complex 100 according to this embodiment makes it possible to significantly reduce the amount of a petroleum fuel to be used, in turn reducing the amount of consumption of crude oil (by approximately 20%), and concurrently to reduce the generation of carbon dioxide (by approximately 20%).

### Second Embodiment

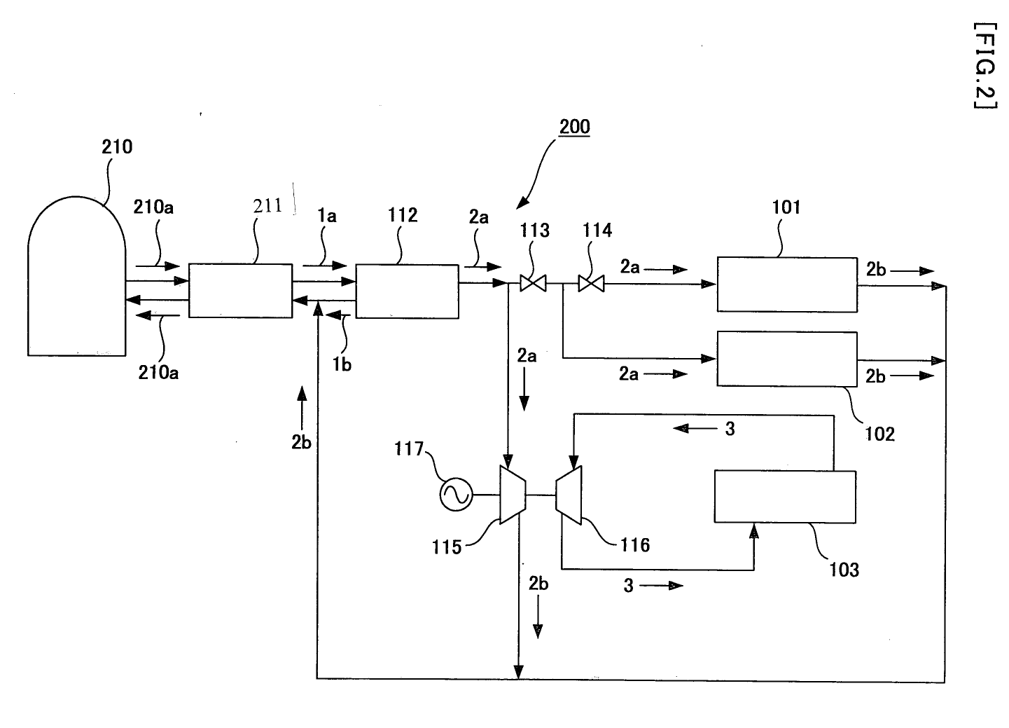

Descriptions will be given of a second embodiment of the petrochemical complex according to the present invention with reference to FIG. 2. FIG. 2 shows a schematic configuration of the petrochemical complex. It should be noted that the same parts as those in the above-described first embodiment will be denoted by the same reference numerals used in the descriptions of the first embodiment, and that the same descriptions as those made in the first embodiment will thus be omitted.

In FIG. 2, reference numeral 210 denotes a fast-breeder reactor, while reference numerals 211 and 112 denote a first steam generator and a second steam generator, respectively. The first steam generator 211 exchanges heat with liquid sodium 210a (of approximately 500° C.) that is a coolant of the fast-breeder reactor 210, thus generating steam 1 serving as a heating medium. The second steam generator 112 exchanges heat with the steam 1a generated in the first steam generator 211, thus generating steam 2a serving as a heating medium. It should be noted that the first and second steam generators 211 and 112 constitute steam generating means in this embodiment.

The petrochemical complex 100 according to the above-described first embodiment employs the light-water reactor 111 of the boiling water type or the pressurized water type as the nuclear reactor. In the petrochemical complex 100, firstly, heat is generated in the light-water reactor 111. Then, the steam 2a is generated by use of the heat so as to be fed to the plants 101 and 102. Concurrently, the heat transfer gas 3 is compressed and heated by used of the steam 2a so as to be fed to the plant 103. In this way, a fuel and a petrochemical are produced from crude oil. On the other hand, a petrochemical complex 200 according to this embodiment employs the fast-breeder reactor 211 as the nuclear reactor. In the petrochemical complex 200, firstly, heat is generated in the fast-breeder reactor 211. Then, the steam 2a is generated by use of the heat so as to be fed to the plants 101 and 102. Concurrently, the heat transfer gas 3 is compressed and heated by use of the steam 2a so as to be fed to the plant 103. In this way, a fuel and a petrochemical are produced from crude oil.

Accordingly, in the petrochemical complex 200 according to this embodiment, when a fuel and a petrochemical are produced from crude oil, it is unnecessary to use the fuel thus produced, as in the case of the petrochemical complex 100 according to the above-described first embodiment. In other words, crude oil can be used only as a material but not as a heat source.

As a result, as in the case of the petrochemical complex 100 according to the above-described first embodiment, the petrochemical complex 200 according to this embodiment makes it possible to significantly reduce the amount of a petroleum fuel to be used, in turn reducing the amount of consumption of crude oil (by approximately 20%), and concurrently to reduce the generation of carbon dioxide (by approximately 20%).

### Third Embodiment

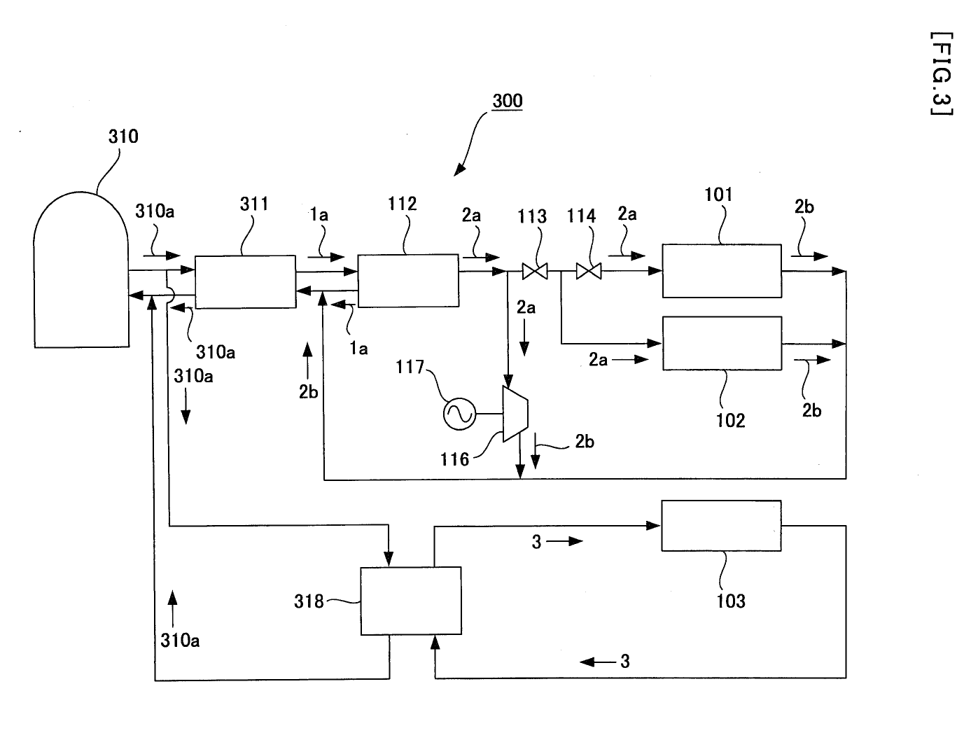

Descriptions will be given of a third embodiment of the petrochemical complex according to the present invention with reference to FIG. 3. FIG. 3 shows a schematic configuration of the petrochemical complex. It should be noted that the same parts as those in the above-described first and second embodiments will be denoted by the same reference numerals used in the descriptions of the first and second embodiments, and that the same descriptions as those made in the first and second embodiments will thus be omitted.

In FIG. 3, reference numeral 310 denotes a high-temperature gas-cooled reactor, while reference numerals 311 and 112 denote a first steam generator and a second steam generator, respectively. The first steam generator 311 exchanges heat with helium gas 310a (of approximately 900° C.) that is a coolant of the high-temperature gas-cooled reactor 310, thus generating steam 1a serving as a heating medium. The second steam generator 112 exchanges heat with the steam 1a generated in the first steam generator 211, thus generating steam 2a serving as a heating medium. It should be noted that the first and second steam generators 311 and 112 constitute steam generating means in this embodiment.

In addition, reference numeral 318 denotes a heat exchanger serving as heat exchanging means. The heat exchanger 318 causes heat transfer gas 3, which is a heating medium, to exchange heat with the helium gas 310a, which is the coolant of the high-temperature gas-cooled reactor 310. The heat exchanger 318 then feeds the heat transfer gas 3 to the high-temperature-range plant 103.

The petrochemical complexes 100 and 200 according respectively to the above-described first and second embodiments employ the light-water reactor 111 and the fast-breeder reactor 211 as the nuclear reactor. In each of the petrochemical complexes 100 and 200, firstly, heat is generated in the corresponding one of the light-water reactor 111 and the fast-breeder reactor 211. Then the steam 2a is generated by use of the heat so as to be fed to the plants 101 and 102. Concurrently, the heat transfer gas 3 is compressed and heated by use of the steam 2a so as to be fed to the plant 103. In this way, a fuel and a petrochemical are produced from crude oil. On the other hand, a petrochemical complex 300 according to this embodiment employs the high-temperature gas-cooled reactor 311 as the nuclear reactor. In the petrochemical complex 300, firstly, heat is generated in the high-temperature gas-cooled reactor 311. Then, the steam 2a is generated by use of the heat so as to be fed to the plants 101 and 102. Concurrently, the heat transfer gas 3 is heated (heat-exchanged) by use of the heat so as to be fed to the plant 103. In this way, a fuel and a petrochemical are produced from crude oil.

Accordingly, in the petrochemical complex 300 according to this embodiment, when a fuel and a petrochemical are produced from crude oil, it is unnecessary to use the fuel thus produced, as in the cases of the petrochemical complexes 100 and 200 according respectively to the above-described first and second embodiments. In other words, crude oil can be used only as a material but not as a heat source.

As a result, as in the cases of the petrochemical complexes 100 and 200 according respectively to the above-described first and second embodiments, the petrochemical complex 300 according to this embodiment makes it possible to significantly reduce the amount of a petroleum fuel to be used, in turn reducing the amount of consumption of crude oil (by approximately 20%), and concurrently to reduce the generation of carbon dioxide (by approximately 20%).

### Other Embodiments

Note that, in the petrochemical complex 100 according to the above-described first embodiment, the steam generating means is constituted of the two steam generators 111 and 112 communicating serially with each other. However, as another embodiment, the steam generating means may be constituted of, for example, three steam generators caused to communicate serially with one another. Employing this configuration makes it possible to further secure the segregation from the light-water reactor 100, and to thus further enhance the safety.

Moreover, in each of the petrochemical complexes 200 and 300 according respectively to the above-described second and third embodiments, the steam generating means is constituted of the two steam generators, that is, one of the generators 211 and 311, as well as the generator 112, caused to communicate serially with each other. However, as another embodiment, for example, when the segregation from the fast-breeder reactor 210 or the high-temperature gas-cooled reactor 310 is sufficient, the steam generating means may be constituted of a single steam generator.

Furthermore, in the petrochemical complex 300 according to the above-described third embodiment, the heat exchanging means is constituted of the single heat exchanger 318. However, as another embodiment, the heat exchanging means may be constituted of, for example, two heat exchangers caused to communicate serially with each other. Employing this configuration makes it possible to further secure the segregation from the high-temperature gas-cooled reactor 310, and to thus further enhance the safety.

### INDUSTRIAL APPLICABILITY

The petrochemical complex according to the present invention makes it possible to significantly reduce the amount of a petroleum fuel to be used, in turn reducing the amount of consumption of crude oil, and concurrently to reduce the generation of carbon dioxide. For this reason, it is industrially very beneficial to employ the present invention.

1. A petrochemical complex that produces a fuel and a petrochemical, by applying heat generated in heating means to crude oil by use of a heating medium,
the petrochemical complex characterized in that
the heating means is a nuclear reactor.

2. The petrochemical complex according to claim 1 characterized in that
the nuclear reactor is a light-water reactor, and
the heating medium is steam generated through heat exchange with a light water that is a coolant of the light-water reactor.

3. The petrochemical complex according to claim 1 characterized in that
the nuclear reactor is a fast-breeder reactor, and
the heating medium is steam generated through heat exchange with liquid sodium that is a coolant of the fast-breeder reactor.

4. The petrochemical complex according to claim 1 characterized in that
the nuclear reactor is a high-temperature gas-cooled reactor, and
the heating medium is steam generated through heat exchange with helium gas that is a coolant of the high-temperature gas-cooled reactor.

5. The petrochemical complex according to claim 1 characterized by comprising:
a light-water reactor serving as the nuclear reactor;
a steam turbine rotationally driven by use of steam generated through heat exchange with a light water that is a coolant of the light-water reactor; and
a compressor connected to the steam turbine, and compressing and feeding a heat transfer gas,
the petrochemical complex characterized in that
the heating medium is the heat transfer gas compressed by, and fed from, the compressor.

6. The petrochemical complex according to claim 1 characterized by comprising:
a fast-breeder reactor serving as the nuclear reactor;
a steam turbine rotationally driven by use of steam generated through heat exchange with liquid sodium that is a coolant of the fast-breeder reactor; and
a compressor connected to the steam turbine, and compressing and feeding a heat transfer gas,
the petrochemical complex characterized in that
the heating medium is the heat transfer gas compressed by, and fed from, the compressor.

7. The petrochemical complex according to claim 1 characterized by comprising a high-temperature gas-cooled reactor serving as the nuclear reactor,
the petrochemical complex characterized in that
the heating medium is a heat transfer gas having exchanged heat with helium gas that is a coolant of the high-temperature gas-cooled reactor.
